(19) United States
(12) Patent Application Publication
(10) Pub. No.: US 2020/0299504 A1
(43) Pub. Date: Sep. 24, 2020

(54) EDC-FREE BIOPOLYMER BASED COMPOSITIONS AND USES THEREOF

(71) Applicant: Truely Inc., La Mesa, CA (US)

(72) Inventor: Joshua David Munoz, La Mesa, CA (US)

(73) Assignee: Truely Inc.

(21) Appl. No.: 16/894,668

(22) Filed: Jun. 5, 2020

Related U.S. Application Data
(63) Continuation of application No. PCT/US18/64581, filed on Dec. 7, 2018.
(60) Provisional application No. 62/595,852, filed on Dec. 7, 2017.

(51) Int. Cl. C08L 67/04; C08L 23/12; C08L 23/06; C08L 23/20; C08L 5/00; C08L 3/02; B65D 65/38; B65D 51/00; B65D 21/02

(52) U.S. Cl. CPC C08L 67/04; C08L 23/12; C08L 23/06; C08L 23/20; B65D 21/0209; C08L 3/02; B65D 65/38; B65D 51/00; C08L 5/00

(57) ABSTRACT

Endocrine disruptor-free biologically-derived plastic formulations, a method of making the same, and a unique design embodiment in a food storage container application. The composition may comprise one or more polymers; one or more additives; and one or more biologically derived components including at least one of the one or more polymers or one or more additives, at least one of the one or more polymers or the one or more additives being substantially free of endocrine-disrupting compounds.

### CROSS-REFERENCED APPLICATIONS

Pursuant to 35 U.S.C. § 120 and 35 U.S.C. § 119(e), this application claims the priority to PCT Application No. PCT/US18/64581 filed on Dec. 7, 2018, based on a claim of priority to U.S. Provisional Application No. 62/595,852 filed Dec. 7, 2017. Contents of the aforementioned patent applications are hereby incorporated by reference herein in their entirety. Any admissions, amendments, characterizations, or other assertions made, previously or going forward, in any related patent applications or patents (including any continuation or continuation-in-part applications or any parent, sibling, or child applications) with respect to any art, prior or otherwise, should not be construed as a disclaimer of any subject matter supported by the disclosure made in the present application. Applicant hereby rescinds and retracts any disclaimers or admissions whatsoever made in any related applications or patents during prosecution or otherwise. Applicant also respectfully submits that any prior art considered in any related patent applications or patents may need to be re-visited and reconsidered as to relevance and applicability to the subject matter disclosed and claimed herein.

### BACKGROUND

Conventional plastic products have become a staple in the homes of modern society since the 1940s and for good reason; they are lightweight, versatile, cost-effective, and convenient. Yet in recent years, there has been a great deal of attention given to the adverse health effects of endocrine-disrupting chemicals contained in conventional fossil fuel-based commodity plastics. The concern arises as these synthetic chemical compounds have been documented in numerous lab studies to migrate, through a process known as chemical leaching, from their plastic resins and into the foods, beverages, and body surfaces they come in contact with, resulting in human and animal absorption. Widely used in the manufacturing and composition of plastic items and materials, the chemical compounds used as catalysts, additives and plasticizers have been found to leach from the petrochemical resins that compose the molded plastic products ubiquitous in the households and lives of the modern society. These synthetic chemical compounds are categorized as endocrine disrupting chemicals (EDCs), also referred to herein as endocrine disrupting compounds, can alter the normal hormone functioning of living organisms. Xenoestrogens are a kind of endocrine disruptor, which possess estrogenic and/or androgenic active effects that mimic and disrupt hormonal and cellular functions naturally occurring in the body. Endocrine disruptors pose a prominent health risk because they alter cellular activity and interfere with hormonal systems in humans and animals, even at incredibly low levels and especially in fetal and juvenile stages, due to their estrogenic and androgenic active (EA and AA) compounds. The resulting cellular disruption attributed to these endocrine disrupting chemicals has been linked to an array of adverse health disorders such as early puberty, obesity, infertility, diabetes, inflammation, microbial dysbiosis and some forms of cancer. While two of the most widely publicized xenoestrogens, BPA and phthalates, have come under public scrutiny; these are only two of the hundreds of synthetic chemicals and additives that are potentially used in the manufacturing process of traditional fossil-fuel derived polymers (referenced throughout this disclosure as petroleum-based, petrochemical plastics and polymers) and their finished commodity and industrial plastic applications.

Furthermore, conventional petroleum-based plastics have also been shown to negatively impact the environment as the production process requires high-energy consumption, greenhouse gas emissions, depletion of the nonrenewable crude-oil feedstock, and increased landfill contribution or environmental pollution at the end of its useful life. Since the 1950s more than 8.3 billion metric tons of the synthetic material has been produced with the majority of the material waste residing in landfills or the natural environment. With a continued rise in global and North American forecasted production demand, plastic will continue to remain an integral part of society. Because of the material's prevalence, not only do these products emit harmful substances when in use, but due to the synthetic nonbiodegradable nature of the material, when disposed of the plastic debris can potentially poison wildlife and contaminate surrounding soil and water bodies through chemical leaching in the natural or landfill environment. Bioplastics comprising renewable biologically derived sources such as starch, lignin, bacteria, and natural gases, to name a few, are a promising emerging alternative that has recently become technologically feasible to exhibit similar properties and economic parity to petroleum-based counterparts and are being employed in many industrial uses as well as beginning to be introduced in commercial applications such as disposable cutlery and dining ware. Nonetheless, many even biologically derived plastics still contain EDCs and there exists a need for plastic products not only derived from biological and renewable materials, but also nontoxic in composition. There remains a demand and unfulfilled market gap to utilize renewably sourced and biologically derived polymers that do not contain endocrine disrupting compounds whether in the polymer or additives, which are applied to reusable not just disposable commercial applications, especially those that come in contact with food and beverages. Utilizing polymers derived from biologically derived feedstock, integrating biological materials into polymer compositions, and/or a combination of the two, coupled by eliminating endocrine disputing compounds from these compositions can present effective solutions for reusable and disposable, home and recreational applications. Solutions to these and other problems are needed.

### SUMMARY

In accordance with example embodiments, a plastic composition including a polymer or a processed biological material is provided. The plastic composition may be free of releasing detectable endocrine disrupting compounds and may be nontoxic. In certain aspects, the polymer may include a biopolymer. The polymer may, for example, include a thermoplastic polymer, a thermoset polymer, an elastomeric polymer, a copolymer blend, or a combination thereof. In some embodiments, the polymer is derived from a living organism or synthesized chemical reactions, the synthesized chemical reactions including polymerization. In certain embodiments, the processed biological material is derived from a living organism. The living organism may include a plant, fungus, animal, protist or bacteria, for example. In certain embodiments, the plastic composition further includes an antimicrobial agent. The processed biological material may include fiber, stalk, cob, skin, peel, coir, husk, hull, pulp, shell, leaf, baste/stem, straw, root, seed, pod, bean, or oil, for example. In some embodiments, the processed biological material is derived from jute, hemp, seed, flax, kenaf, ramie, roselle, mesta, palm, sisal, banana, abaca, alfa, palf, henequen, agave, raphia, rice straw, kapok, loofah, cotton, wheat, rice, barley, oat, rye, bamboo, bagasse, corn, sabai, rape, esparto, canary, African kino, sugarcane, pine, cacao, coffee, peanut, tree nut, olive, coconut, pineapple, mango, pomegranate, blueberry, apple, orange, lemon, lime, grapefruit, grape, watermelon, tomato, potato, avocado, seaweed and algal derivatives, reeds, grasses, trees, or other agricultural products. The processed biological material may be an antimicrobial biological material. In certain embodiments, the plastic composition further includes an antimicrobial agent, wherein the antimicrobial agent may include a plant extract, essential oil, silver particles, silver particle derivatives, chitosan, algae, algae derivatives, agricultural waste products or other antimicrobial active compound. In certain embodiments, the plastic composition further includes a stabilizer, filler, binder, modifier, clarifier, plasticizer, antioxidant, colorant, processing aid or other additives; wherein the stabilizer, filler, binder, modifier, clarifier, plasticizer, antioxidant, colorant, processing aid or additives are free of endocrine disrupting compounds, and are nontoxic.

In accordance with one aspect a molded plastic is provided that may include the plastic composition as described herein, including embodiments where the molded plastic is a storage container, food storage container, storage and freezer bag or pouch, dining ware, serve ware, cutlery, cooking utensil, stirring spoon, spatula, kitchen gadget, mug, cup, cap, bowl, lid, beverage bottle, baby bottle, spray bottle, pitcher, liquid pourer, liquid dispenser, ice-tray, tray, spice holder, condiment dispenser, baking ware, baking accessory, toothbrush, oral appliance or instrument, blender, baby product, toy, cosmetic container, soap and body care dispensers and holder, deodorant container, pen, pencil, phone case, wrist band, watchband, pet feeder, pet bowl, headphones, cable and housing, piping, bin, basket, grocery bag, shopping bag, waste basket, textile, furniture or other molded product for personal or industrial use.

Depending on implementation, a method of making a plastic composition including a polymer and/or a processed biological material is provided, wherein the plastic composition is free of any endocrine disrupting compounds. The method may include mixing a polymer and/or a processed biological material thereby forming a plastic composition that is free of releasing detectable endocrine disrupting compounds and features a biobased component not derived from fossil fuels.

### BRIEF DESCRIPTION OF THE DRAWINGS

FIG. 1A and FIG. 1B depict a high-level overview of possible production processes for making the bioplastic material and ultimately the molded plastic product. As shown, the polymer and its catalyst, modifiers and other additives are derived from nontoxic and EDC-free compounds. A biological material such as plant fiber is potentially used to reinforce a bioplastic resin (e.g., a polymer described herein) with appropriate EDC-free additives. The biological material may have already been dried, processed, and treated being sourced in a processed state for mixing with the polymer base in (Step 1.7). FIG. 1B incorporates the steps of processing and/or treating the plant matter, if the biological material is sourced unprocessed, into the desired particle size with desired mechanical and thermal properties (Steps 1.1, 1.2), whereby the grinding process may include pulverization methods such as ball milling, jet milling, hammer milling, turbo milling, dry milling, bead milling, cryogenic grinding or some other mechanical or chemical process, for example. The treatment method may involve a chemical process such as hydrolysis, alkali treatment, oxygen or peroxide treatment, or other treatment to isolate the fibers for extraction from its natural unprocessed plant state. Isolation, pulverization and treatment of the biological material allows for enhanced compatibility and dispersion of the biological matter throughout the plastic composite and further yield the desired mechanical and thermal properties. The selected EDC-free plastic polymer or polymer blend (Step 1.4) is mixed with the desired additives and modifying agents (Step 1.5), and if incorporating a processed biological material component, it is mixed as well into a homogeneous mixture (Step 1.7). This mixture is then further processed into pellet or other filament form (Step 1.9) by methods such as extrusion compounding and the like. The compounded bioplastic pellets are then molded, whether through molding methods such as injection, blow, compression, extrusion, thermoforming and the like, into their commercial product applications (Step 1.11).

FIGS. 2 through 6B show example renderings of a plastic food storage container. The container is designed such that the lid fastens onto the top parameter of the container. In some embodiments, the lid may also fastens or rests onto the bottom of the container base for storage and stacking functionality. An interlocking rim, or other feature, may exist on both the top and bottom of the midsection to hold the lid on top and when resting on bottom, respectively. This is just one example of an embodiment of the biopolymer plastic application and is not limiting in shape, size, color, dimension, or other characteristics.

FIG. 2 depicts one lid and a container base, wherein the lid can fasten to both the top rim and bottom base of the container. The vertically drawn curved arrow on the left of the container serves to illustrate the flipped nesting functionality and action of securing a lid onto both the top and bottom of the container in accordance with one or more embodiments. The lid may feature a connected lip, for example, for easy removal and fastening of the lid from the top or bottom base of the container.

FIGS. 3A through 3D show how the lid fastens onto the top rim of the container, including sectional views to depict the interlocking rim and lid feature that fastens the lid onto the top when covering the container contents.

FIGS. 4A through 4D show how the lid fastens onto the bottom of the container base, with sectional views to convey the interlocking lid and base feature that fastens the lid onto the bottom when accessing contents in the container or storing when not in use. The inner rim around the parameter of the lid fastens onto the indentation that wraps around the lower portion of the container's midsection.

FIGS. 5A through 5B depict the stacking functionality when storing two containers on top of each other. As seen in the sectional view, a portion of the container rests within the underlying container to save space during storage. A slight indentation at a midpoint on the lid, just above the lip, encircles each side; this indentation around the lid serves as the resting point where the upper container rests to such depth within the underling container.

FIGS. 6A through 6B show a planar top view of the container (FIG. 6A) and a planar bottom view of the container (FIG. 6B). The top view depicts the transparent viewing window or surface to allow for viewing of the container's contents. The bottom view shows a potential concaved indentation in the bottom for increased stability when resting stationary rather than a completely flat surface.

### DETAILED DESCRIPTION OF EXAMPLE EMBODIMENTS

The aspects and embodiments described herein relate to bioplastic products and natural fiber composites, and a process for making such products and, more particularly, to bioplastic products that are substantially free from endocrine disrupting chemicals, antimicrobial, and have replaced fossil fuel-based polymers or chemicals either wholly or in part with biologically derived renewable feedstock or materials. In addition, the functional design and features of a food storage container embodiment are also disclosed herein. Disclosed herein, inter alia, are endocrine disruptor-free antimicrobial biopolymer plastic formulation, a method of making the same, and a unique design embodiment in a food storage container application. The polymer resin (i.e. plastic base) is preferably derived from EDC-free biobased feedstock, but can also include EDC-free fossil fuel derived polymer(s). The bioplastic may also incorporate plant fibers and/or other biological materials, preferably with inherent antimicrobial properties, as a natural functional filler to the biopolymer. The biological material is treated and/or processed into fine particles to achieve enhanced dispersion and integration into the polymer/copolymer base with desired mechanical and thermal properties. The EDC-free biopolymer is mixed with EDC-free additives, colorants, processing aids and other modifiers suitable for the application, along with an EDC-free coupling agent if a biological filler material is incorporated, through a compounding method such as extrusion. The bioplastic or bioplastic composite is then molded into the article of manufacture. One such embodiment of the described bioplastic is a food storage container where the lid top fastens onto the bottom base, featuring improved space-saving and stacking functionality provided when the lid is fastened as such.

### I. Definitions

The abbreviations used herein have their conventional meaning within the chemical and biological arts.

As used herein, the term “about” means a range of values including the specified value, which a person of ordinary skill in the art would consider reasonably similar to the specified value. In certain embodiments, about means within a standard deviation using measurements generally acceptable in the art. In certain embodiments, about means a range extending to +/−10% of the specified value. In certain embodiments, about includes the specified value.

The term “polymer” refers to a molecule including repeating subunits (e.g., polymerized monomers). For example, polymeric molecules may be based upon polyethylene glycol (PEG), poly[amino(1-oxo-1, 6-hexanediyl)], poly(oxy-1,2-ethanediyloxycarbonyl-1,4-phenylenecarbonyl), tetraethylene glycol (TEG), polyvinylpyrrolidone (PVP), poly(xylene), or poly(p-xylylene). Non-limiting examples of a polymer include a thermoplastic polymer, a thermoset polymer, an elastomeric polymer, a starch derivative, polyvinyl alcohol (PVA), polybutylene succinate (PBS), poly(butylene adipate-co-terephthalate) (PBAT), polycaprolactone (PCL), polylactic acid (PLA), PLA derivative, protein derived polymer, chitin, chitin derivatives, chitosan, chitosan derivatives, bio-based polyethylene (bio-PE), bio-based polyethylene terephthalate (bio-PET), bio-based polyamide (bio-PA), polyhydroxyalkanoate (PHA), polyhydroxybutyrate (PHB), polyhydroxyvalerate (PHBV), polyhydroxyhexanoate (PHH), poly(L-lactic acid) (PLLA), polyhydroxyurethane (PHU), lipid derived polymer, cellulose, cellulose acetate, nitrocellulose, celluloid, cellulose derivative, lignin, lignin derivative; yeast derived polymer, bacteria derived polymer, polyethylene furanoate (PEF), polypropylene (PP), polyurethane (PU), polyethylene (PE), high-density polyethylene (HDPE), low-density polyethylene (LDPE), polyethylene terephthalate (PET), glycol-modified polyethylene terephthalate (PETG), polyvinylidene chloride (PVDC), polyamide (PA), nylon, polystyrene (PS), high impact polystyrene (HIPS), polyester, polyether sulfone (PES), cyclic olefin polymer (COP), cyclic olefin copolymer (COC), silicone, polyoxymethylene, polycarbonate (PC), acrylic (PMMA), acrylonitrile styrene acrylate, polybutylene terephthalate, or a copolymer thereof. In certain embodiments, the polymer is a biopolymer, a biodegradable petrochemical polymer, or a nondegradable petrochemical polymer. A biopolymer, as used herein, refers to a polymer derived from a living organism.

The term “polymerizable monomer” is used in accordance with its meaning in the art of polymer chemistry and refers to a compound that may covalently bind chemically to other monomer molecules (such as other polymerizable monomers that are the same or different) to form a polymer.

The term “branched polymer” is used in accordance with its meaning in the art of polymer chemistry and refers to a molecule including repeating subunits, wherein at least one repeating subunit (e.g., polymerizable monomer) is covalently bound to an additional subunit substituent (e.g., resulting from a reaction with a polymerizable monomer). For example, a branched polymer has the formula provided below, where ‘A’ is the first repeating subunit and ‘13’ is the second repeating subunit. In certain embodiments, the first repeating subunit (e.g., polyethylene glycol) is optionally different than the second repeating subunit (e.g., polymethylene glycol):

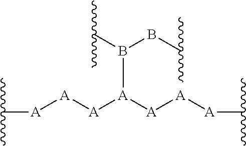

The term “block copolymer” is used in accordance with its ordinary meaning and refers to two or more portions (e.g., blocks) of polymerized monomers linked by a covalent bond. In certain embodiments, a block copolymer is a repeating pattern of polymers. In certain embodiments, the block copolymer includes two or more monomers in a periodic (e.g., repeating pattern) sequence. For example, a diblock copolymer has the formula: -B-B-B-B-B-B-A-A-A-A-A-, where ‘B’ is a first subunit and ‘A’ is a second subunit covalently bound together. A triblock copolymer therefore is a copolymer with three distinct blocks, two of which may be the same (e.g., -A-A-A-A-A-B-B-B-B-B-B-A-A-A-A-A-) or all three are different (e.g., -A-A-A-A-A-B-B-B-B-B-B-C-C-C-C-C-) where ‘A’ is a first subunit, ‘B’ is a second subunit, and ‘C’ is a third subunit, covalently bound together.

The term “processed biological material” as used herein refers to a biotic material (i.e., a material produced by a living organism) which is subjected to mechanical or chemical operations (e.g., pulverization methods such as ball milling, jet milling, hammer milling, turbo milling, dry milling, bead milling, cryogenic grinding or some other mechanical process, or hydrolysis), to render it useful in a plastic composition (e.g., a biocomposite). For example, to be useful in a plastic composition the processed biological material must meet certain size requirements (e.g., the longest dimension of the processed biological material is about 1-100 μm), or specific moisture content requirements (e.g., less than 50% moisture content). Processed biological material may be derived from plants (e.g., seed fiber, leaf fiber, bast fiber, fruit fiber, stalk fiber) or animal fiber (e.g., proteins such as collagen, keratin, chitin, or fibroin). In certain embodiments, the processed biological material is derived from fiber, stalk, cob, skin, peel, coir, husk, hull, pulp, shell, leaf, baste/stem, straw, root, seed, pod, bean, or oil. In certain embodiments, the processed biological material is derived from jute, hemp, seed, flax, kenaf, ramie, roselle, mesta, palm, sisal, banana, abaca, palf, henequen, agave, raphia, rice straw, kapok, loofah, cotton, wheat, rice, barley, oat, rye, bamboo, bagasse, corn, sabai, rape, esparto, canary, African kino, sugarcane, pine, cacao, coffee, peanut, tree nut, olive, coconut, pineapple, mango, pomegranate, blueberry, apple, orange, lemon, lime, grapefruit, grape, watermelon, tomato, potato, avocado, seaweed and algal derivatives, reeds, grasses, trees, and/or agricultural products.

The term “endocrine disrupting chemicals (EDCs)” or “endocrine disrupting compounds” or “hormonally active agents” are used interchangeably and refer to compounds known to modulate the synthesis, secretion, transport, binding, action, or elimination of natural hormones in the body that are responsible for development, behavior, fertility, and maintenance of homeostasis. A range of substances, both natural and man-made, are understood to cause endocrine disruption, including pharmaceuticals, dioxin and dioxin-like compounds, polychlorinated biphenyls, DDT and other pesticides, and plasticizers such as bisphenol A. EDEs have been claimed to follow a U-shaped dose response curve; meaning that at very low and very high concentrations EDEs have more effects than mid-level exposure. Non-limiting examples of EDEs include Xenoestrogens (e.g., a xenohormone that imitates estrogen), alkylphenols, bisphenol A (BPA), bisphenol S (BPS), dichlorodiphenyltrichloroethane (DDT), polychlorinated biphenyls (PCBs), Polybrominated diphenyl ethers (PBDEs), phthalates, di(2-ethylhexyl) phthalate (DEHP), and perfluorooctanoic acid (PFOA).

The term “modulate” is used in accordance with its plain ordinary meaning and refers to the act of changing or varying one or more properties. “Modulation” refers to the process of changing or varying one or more properties. For example, as applied to the effects of a modulator on a target protein, to modulate means to change by increasing or decreasing a property or function of the target molecule or the amount of the target molecule.

The term “antimicrobial agent” is used in accordance with its plain ordinary meaning and refers to an agent that inhibits the level or activity of a microorganism (e.g., bacteria). In certain embodiments, the antimicrobial agent is a plant extract, blueberry extract, grape seed extract, green tea extract, essential oil, silver particles, silver particle derivatives, chitosan, algae, algae derivatives, and/or agricultural waste product.

The term “fiber” is used in accordance with its plain ordinary meaning and refers to a natural or synthetic filament. Natural fibers include those produced by plants or animals. Vegetable fibers are generally based on arrangements of cellulose, often with lignin: non-limiting examples include cotton, hemp, jute, flax, ramie, sisal, bagasse, and banana. Wood fiber, is from tree sources. Forms include groundwood, lacebark, thermomechanical pulp (TMP), and bleached or unbleached kraft or sulfite pulps. Kraft and sulfite (also called sulphite) refer to the type of pulping process used to remove the lignin bonding the original wood structure, thus freeing the fibers for use in paper and engineered wood products such as fiberboard. Animal fibers include particular proteins. Non-limiting examples include silkworm silk, spider silk, sinew, catgut, wool, sea silk and hair such as cashmere wool, mohair and angora, fur such as sheepskin, rabbit, mink, fox, beaver. Fibers may include cellulose, hemi-cellulose, lignin, pectin, waxes, or water-soluble components.

### II. Plastic Compositions

In accordance with one or more embodiments, a plastic composition including a polymer and/or a processed biological material is provided. The plastic composition may be substantially free of releasing detectable endocrine disrupting compounds. In certain embodiments, the plastic composition further includes an antimicrobial agent, wherein the antimicrobial agent is a plant extract, blueberry extract, grape seed extract, green tea extract, essential oil, silver particles, silver particle derivatives, chitosan, algae, algae derivatives, and/or other agricultural waste products (e.g., cereal straw, sawdust, woodchips, waste wood particulates, bark, newsprint, paper, or cardboard). In certain embodiments, the plastic composition further includes a stabilizer, filler, plasticizer, or colorant, wherein the stabilizer, filler, plasticizer, or colorant are free of endocrine disrupting compounds, and are nontoxic.

In certain embodiments, the polymer is a thermoplastic polymer, a thermoset polymer, an elastomeric polymer, or a copolymer bend thereof. In certain embodiments, the polymer is derived from a living organism, synthesized chemical reaction, or petrochemical catalysis. In certain embodiments, the synthesized chemical reactions include polymerization. In certain embodiments, the living organism is a plant, fungus, animal, protist or bacteria. In certain embodiments, the polymer is PHB. In certain embodiments, the polymer is PLA. In certain embodiments, the polymer (e.g., polymer resin) is preferably sourced from non-fossil fuel, biobased polymer sources, but may also be derived from synthetic EDC-free petrochemical catalysis (e.g., a fossil fuel polymer source).

In certain embodiments, the processed biological material is derived from a living organism. In certain embodiments, the living organism is a plant, fungus, or prokaryote.

In certain embodiments, the polymer is a polysaccharide derivative, starch derivative, protein derivative, soy protein plastic (SPP), sugar beet pulp plastic (SBP), chitin, chitin derivatives, chitosan, chitosan derivatives, thermoplastic starch (TPS), polylactides, polylactic acid (PLA), PLA derivative, polyvinyl alcohol (PVA), alginate, bio-based polypropylene (bio-PP), biobased polyvinyl chloride (bio-PVC), bio-based polycarbonate (bio-PC), bio-based polyethylene (bio-PE), bio-based polyethylene variants, bio-based polyethylene glycol/oxide (bio-PEG/PEO), bio-based polyethylene terephthalate (bio-PET), polyethylene isosorbide terephthalate (PEIT), polyethylene furanoate (PEF), furan-based derivative, biobased furfural compounds, bio-based polyamides (bio-PA), bio-based polyurethane (bio-PUR), polyhydroxyalkanoate (PHA), polyhydroxyalkanoate derivatives, polyhydroxybutyrate (PHB), poly(3-hydroxybutyrate-co-lactide) (PHBV), polyhydroxybutyrate derivatives, polybutylene succinate (PBS), poly(butylene adipate-co-terephthalate) (PBAT), polybutylene terephthalate (PBT), polytrimethylene terephthalate (PTT), bio-based polyethylene terephthalate (bio-PET), polyhydroxyvalerate (PHBV), polyhydroxyhexanoate (PHH), poly(L-lactic acid) (PLLA), polyhydroxyurethane (PHU), lipid derived polymer, cellulose, cellulose acetate (CA), cellulose acetate butyrate (CAB), cellulose acetate propionate (CAP), cellulose nitrate (CN), nitrocellulose, celluloid, cellulose derivative, lignin, lignin derivative, yeast derived polymer, bacteria derived polymer, or a copolymer thereof.

In certain embodiments, the polymer is polypropylene (PP), polyacrylonitrile (PAN), polyurethane (PU), polyethylene (PE), high-density polyethylene (HDPE), low-density polyethylene (LDPE), polyamides (PAs), poly(butylene succinate-co-adipate (PBSA), poly(butylene succinate-co-lactide (PBSL), poly(butylene succinate-co-terephthalate (PBST), polycaprolactones (PCL), polyethylene terephthalate (PET), glycol-modified polyethylene terephthalate (PETG), polytrimethylene (PTT), polyvinyl chloride (PVC), polyvinylidene chloride (PVDC), polyamides (PAs), nylon, polystyrene (PS), high impact polystyrene (HIPS), polyester, polyether sulfone (PES), cyclic olefin polymer (COP), cyclic olefin copolymer (COC), polydimethylsiloxane (silicone), silicone derivative, polyoxymethylene, polycarbonate (PC), polymethyl methacrylate (PMMA, acrylic), acrylonitrile-butadiene-styrene (ABS), ethylene vinyl acetate (EVA), thermoplastic polyolefin (TPO), acrylonitrile styrene acrylate, styrene-butadiene rubber (SBR), polybutylene terephthalate, or a copolymer thereof.

In certain embodiments, the polymer is a starch derivative, polyvinyl alcohol (PVA), polybutylene succinate (PBS), polylactic acid (PLA), PLA derivative, protein derived polymer, chitin, chitin derivatives, chitosan, chitosan derivatives, bio-based polyethylene (PE), bio-based polyethylene terephthalate (PET), bio-based polyamide (PA), polyhydroxyalkanoate (PHA), poly(butylene adipate-co-terephthalate) (PBAT), polycaprolactone (PCL), polyhydroxybutyrate PHB, polyhydroxyvalerate PHBV, polyhydroxyhexanoate (PHH), poly(L-lactic acid) (PLLA), polyhydroxyurethane (PHU), lipid derived polymer, cellulose, cellulose acetate, nitrocellulose, celluloid, cellulose derivative, lignin, lignin derivative; yeast derived polymer, bacteria derived polymer, polyethylene furanoate (PEF), or a copolymer thereof.

In certain embodiments, the polymer is polypropylene (PP), polyurethane (PU), polyethylene, high-density polyethylene (HDPE), low-density polyethylene (LDPE), polyethylene terephthalate (PET), glycol-modified polyethylene terephthalate (PETG), polyvinylidene chloride (PVDC), polyamide (PA), nylon, polystyrene (PS), high impact polystyrene (HIPS), polyester, polyether sulfone (PES), cyclic olefin polymer (COP), cyclic olefin copolymer (COC), silicone, polyoxymethylene, polycarbonate (PC), acrylic (PMMA), acrylonitrile styrene acrylate, polybutylene terephthalate, or a copolymer thereof.

In certain embodiments, the polymer is polypropylene (PP), polyacrylonitrile (PAN), polyurethane (PU), polyethylene (PE), high-density polyethylene (HDPE), low-density polyethylene (LDPE), polyamides (PAs), polyether ether ketone (PEEK), poly(butylene succinate-co-adipate (PBSA), poly(butylene succinate-co-lactide (PBSL), poly(butylene succinate-co-terephthalate (PBST), polycaprolactones (PCL), polyethylene terephthalate (PET), glycol-modified polyethylene terephthalate (PETG), polytrimethylene (PTT), polyvinyl chloride (PVC), polyvinylidene chloride (PVDC), nylon, polystyrene (PS), high impact polystyrene (HIPS), polyester, polyether sulfone (PES), cyclic olefin polymer (COP), cyclic olefin copolymer (COC), polydimethylsiloxane (silicone), silicone derivative, polyoxymethylene, polycarbonate (PC), polymethyl methacrylate (PMMA, acrylic), acrylonitrile-butadiene-styrene (ABS), ethylene vinyl acetate (EVA), thermoplastic polyolefin (TPO), acrylonitrile styrene acrylate, styrene-butadiene rubber (SBR), polybutylene terephthalate, or a copolymer thereof.

In certain embodiments, the processed biological material is fiber, stalk, cob, skin, peel, coir, husk, hull, pulp, shell, leaf, baste/stem, straw, root, seed, pod, bean, or oil. In certain embodiments, the processed biological material is fiber.

In certain embodiments, the processed biological material is derived from jute, hemp, seed, flax, kenaf, ramie, roselle, mesta, palm, sisal, banana, abaca, palf, henequen, agave, raphia, kapok, loofah, cotton, wheat, rice, barley, oat, rye, bamboo, bagasse, corn, sabai, rape, esparto, canary, African kino, sugarcane, rice straw, pine, cacao, coffee, peanut, tree nut, olive, coconut, pineapple, mango, pomegranate, blueberry, apple, orange, lemon, lime, grapefruit, grape, watermelon, tomato, potato, avocado, seaweed and algal derivatives, reeds, grasses, trees, and/or other agricultural products (e.g., cereal straw, sawdust, woodchips, waste wood particulates, bark, newsprint, paper, or cardboard).

In certain embodiments, the longest dimension of the processed biological material (e.g., fiber) is less than 1 μm. In certain embodiments, the longest dimension of the processed biological material (e.g., fiber) is less than 2 μm. In certain embodiments, the longest dimension of the processed biological material (e.g., fiber) is less than 3 μm. In certain embodiments, the longest dimension of the processed biological material (e.g., fiber) is less than 4 μm. In certain embodiments, the longest dimension of the processed biological material (e.g., fiber) is less than 5 μm.

In certain embodiments, the longest dimension of the processed biological material (e.g., fiber) is about 1 μm. In certain embodiments, the longest dimension of the processed biological material (e.g., fiber) is about 2 μm. In certain embodiments, the longest dimension of the processed biological material (e.g., fiber) is about 3 μm. In certain embodiments, the longest dimension of the processed biological material (e.g., fiber) is about 4 μm. In certain embodiments, the longest dimension of the processed biological material (e.g., fiber) is about 5 μm.

In certain embodiments, the longest dimension of the processed biological material (e.g., fiber) is less than 1 mm. In certain embodiments, the longest dimension of the processed biological material (e.g., fiber) is less than 2 mm. In certain embodiments, the longest dimension of the processed biological material (e.g., fiber) is less than 3 mm. In certain embodiments, the longest dimension of the processed biological material (e.g., fiber) is less than 4 mm. In certain embodiments, the longest dimension of the processed biological material (e.g., fiber) is less than 5 mm.

In certain embodiments, the longest dimension of the processed biological material (e.g., fiber) is about 1 mm. In certain embodiments, the longest dimension of the processed biological material (e.g., fiber) is about 2 mm. In certain embodiments, the longest dimension of the processed biological material (e.g., fiber) is about 3 mm. In certain embodiments, the longest dimension of the processed biological material (e.g., fiber) is about 4 mm. In certain embodiments, the longest dimension of the processed biological material (e.g., fiber) is about 5 mm.

In certain embodiments, the longest dimension of the processed biological material (e.g., fiber) is about 1 nm to about 1 μm. In certain embodiments, the longest dimension of the processed biological material (e.g., fiber) is about 10 nm to about 1 μm. In certain embodiments, the longest dimension of the processed biological material (e.g., fiber) is about 100 nm to about 1 μm. In certain embodiments, the longest dimension of the processed biological material (e.g., fiber) is about 500 nm to about 1 μm.

In certain embodiments, the longest dimension of the processed biological material (e.g., fiber) is about 1 nm to about 1 mm. In certain embodiments, the longest dimension of the processed biological material (e.g., fiber) is about 10 nm to about 1 mm. In certain embodiments, the longest dimension of the processed biological material (e.g., fiber) is about 100 nm to about 1 mm. In certain embodiments, the longest dimension of the processed biological material (e.g., fiber) is about 500 nm to about 1 mm.

In certain embodiments, the longest dimension of the processed biological material (e.g., fiber) is about 1 mm to about 5 mm. In certain embodiments, the longest dimension of the processed biological material (e.g., fiber) is about 10 nm to about 5 mm. In certain embodiments, the longest dimension of the processed biological material (e.g., fiber) is about 100 nm to about 5 mm. In certain embodiments, the longest dimension of the processed biological material (e.g., fiber) is about 500 nm to about 5 mm.

In certain embodiments, the processed biological material is antimicrobial biological material. In certain embodiments, antimicrobial additives may be added to processed biological material (e.g., fibers) (e.g., silver, organosilanes, copper and its alloys, such as brass, bronze, cupronickel, or copper-nickel-zinc) to form the antimicrobial processed biological material (e.g., fibers). In certain embodiments, antimicrobial additives may be added to processed biological material (e.g., fibers) (e.g., plant extract, blueberry extract, grape seed extract, green tea extract, essential oil, silver particles, silver particle derivatives, chitosan, algae, algae derivatives, and/or antimicrobial agricultural waste products) to form the antimicrobial processed biological material (e.g., fibers).

In certain embodiments, the plastic composition further includes an antimicrobial agent, wherein the antimicrobial agent is a plant extract, essential oil, silver particles, silver particle derivatives, chitosan, algae, algae derivatives, agricultural waste products or other antimicrobial active compound.

In certain embodiments, the plastic composition includes a processed biological material at a weight percentage of 1%. In certain embodiments, the plastic composition includes a processed biological material at a weight percentage of 10%. In certain embodiments, the plastic composition includes a processed biological material at a weight percentage of 20%. In certain embodiments, the plastic composition includes a processed biological material at a weight percentage of 30%. In certain embodiments, the plastic composition includes a processed biological material at a weight percentage of 40%. In certain embodiments, the plastic composition includes a processed biological material at a weight percentage of 50%. In certain embodiments, the plastic composition includes a processed biological material at a weight percentage of 60%. In certain embodiments, the plastic composition includes a processed biological material at a weight percentage of 70%. In certain embodiments, the plastic composition includes a processed biological material at a weight percentage of 80%. In certain embodiments, the plastic composition includes a processed biological material at a weight percentage of 90%. In certain embodiments, the plastic composition includes a processed biological material at a weight percentage of 99%.

In certain embodiments, the plastic composition includes a polymer at a weight percentage of 1%. In certain embodiments, the plastic composition includes a polymer at a weight percentage of 10%. In certain embodiments, the plastic composition includes a polymer at a weight percentage of 20%. In certain embodiments, the plastic composition includes a polymer at a weight percentage of 30%. In certain embodiments, the plastic composition includes a polymer at a weight percentage of 40%. In certain embodiments, the plastic composition includes a polymer at a weight percentage of 50%. In certain embodiments, the plastic composition includes a polymer at a weight percentage of 60%. In certain embodiments, the plastic composition includes a polymer at a weight percentage of 70%. In certain embodiments, the plastic composition includes a polymer at a weight percentage of 80%. In certain embodiments, the plastic composition includes a polymer at a weight percentage of 90%. In certain embodiments, the plastic composition includes a polymer at a weight percentage of 99%.

In certain embodiments, the plastic composition further includes additional additives, such as corn oil, color additives, or plasticizers (e.g., diethyl phthalate or tri-acetic acid ester of glycerin).

In certain embodiments, the plastic composition further includes a stabilizer, filler, binder, modifier, clarifier, plasticizer, antioxidant, colorant, processing aid, or other additives; wherein the stabilizer, filler, binder, modifier, clarifier, plasticizer, antioxidant, colorant, processing aid, or additives are free of endocrine disrupting elements, and are nontoxic

In certain embodiments, the polymer is ethyl vinyl alcohol, high-density polyethylene, low-density polyethylene, polystyrene, acrylic polymer, polycarbonate, cellulose acetate, cellulose nitrate, nylon, or co-polymers thereof.

In another aspect is provided a molded plastic including the plastic composition as described herein, including embodiments, wherein the molded plastic is a food storage container, storage and freezer bag, dining ware, serve ware, cutlery, cooking utensils, kitchen gadgets, cup, cap, lid, beverage bottle, baby bottle, spray bottle, pitcher, liquid pourer and dispensers, ice-tray, spice holder, condiment dispenser, baking ware, baking accessory, toothbrush, blender, baby products, toy, cosmetic container, soap and body care dispensers and holders, deodorant containers, pen, pencil, phone case, wrist band, watchband, pet feeder, pet bowl, headphones, cable and housing, piping, bin, basket, grocery bag, shopping bag, waste basket, textile, or furniture. In certain embodiments, the molded plastic is a food storage container and lid, wherein the lid secures onto the bottom base of the food storage container.

### III. Methods of Making

In accordance with certain aspects, a method of making a plastic composition including a polymer is provided. The plastic composition may be substantially free of any endocrine disrupting compounds. The method may include mixing a polymer to form a plastic composition substantially free of endocrine disrupting elements. In certain embodiments, the plastic composition further includes an antimicrobial agent, wherein the antimicrobial agent is a plant extract, blueberry extract, grape seed extract, green tea extract, essential oil, silver particles, silver particle derivatives, chitosan, algae, algae derivatives, agricultural waste products, or other antimicrobial active compound. In certain embodiments, the plastic composition further includes a stabilizer, filler, plasticizer, or colorant, wherein the stabilizer, filler, plasticizer, or colorant are free of endocrine disrupting elements, and are nontoxic.

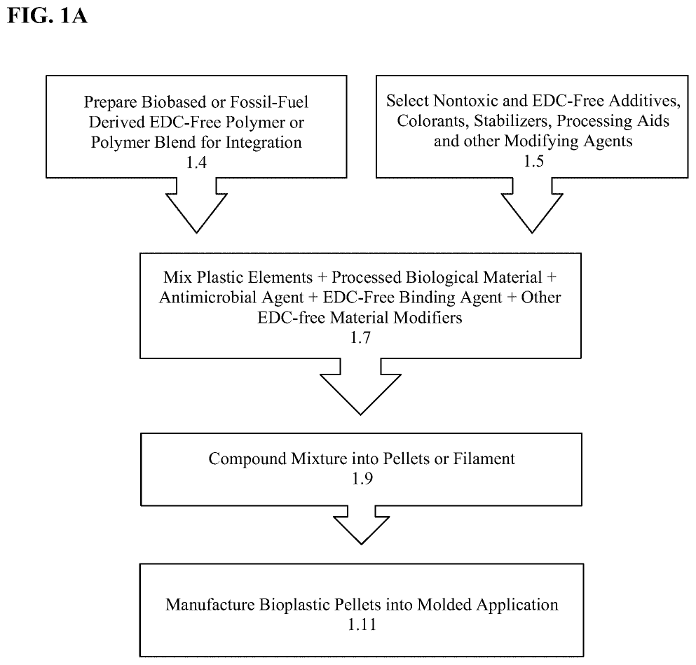

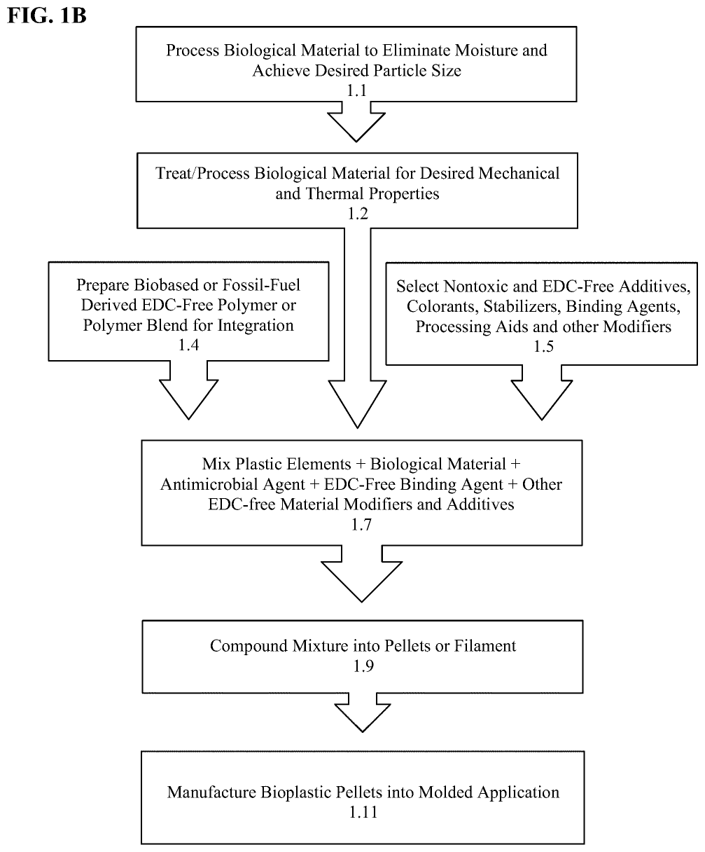

In certain embodiments, the method depicted in FIGS. 1A through 1B may be utilized. In certain embodiments, the method depicted in FIG. 1A may be utilized. In certain embodiments, the method is depicted in FIG. 1B may be utilized.

In certain embodiments, the method includes drying the biological material. Following the drying, the method may include processing (e.g., milling) to reduce the biological material to a desired particle size (e.g., less than 5 mm).

In certain embodiments, the method may include mixing a polymer and a processed biological material, wherein the plastic composition is substantially free of any endocrine disrupting elements. In certain embodiments, the method includes further adding an antimicrobial Agent, an EDC-Free binding agent, and/or a nontoxic coloring agent. The mixture may be extruded into pellets, which may then be manufactured into a bioplastic composite for a desired application.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### EXAMPLES

### Example 1: Biobased Antimicrobial and Endocrine Disruptor-Free Plastic and Fiber Composites, a Method of Producing the Same, and a Food Storage Container

Conventional plastic products have become a staple in the homes of modern society since the 1940s and for good reason; they are lightweight, versatile, cost-effective, and convenient. Yet in recent years, there has been a great deal of attention given to the adverse health effects of endocrine-disrupting chemicals contained in conventional fossil fuel-based commodity plastics. The concern arises as these synthetic chemical compounds have been documented in numerous lab studies to migrate, through a process known as leaching, from their plastic resins and into the foods and beverages they contain or skin they contact, resulting in human and animal absorption. These chemicals, additives and plasticizers found to leach from the petrochemical resins that compose conventional molded plastic products are known as endocrine disrupting chemicals (EDCs; also referred to herein as endocrine disrupting elements), which are estrogenic and/or androgenic active compounds that mimic and disrupt hormones naturally occurring in the body. Endocrine disruptors pose a great health risk because they alter cellular activity and interfere with hormonal systems in humans and animals, even at incredibly low levels and especially in fetal and juvenile stages, due to their estrogenic and androgenic active (EA and AA) compounds. The resulting disruption has been linked to an array of adverse health disorders such as early puberty, obesity, infertility, and some forms of cancer. While the two most publicized culprits, BPA and phthalates, have come under public scrutiny; these are only two of the thousands of potential synthetic chemicals and additives that are used in the manufacturing process of fossil-fuel derived plastics (referenced throughout this disclosure as petroleum-based, petrochemical plastics and polymers). Disclosed herein, inter alia, are solutions to these and other problems in the art.

In addition, conventional petroleum based plastics have also been shown to cause harm to the environment as its production requires high energy consumption, green-house gas emissions, depletion of their nonrenewable crude-oil feedstock, and increased landfill contribution at the end of its useful life. Because of the synthetic nonbiodegradable nature of the materials, not only do these products emit harmful substances when in use, but upon disposal the plastic debris can potentially poison wildlife and contaminate surrounding soil and groundwater through chemical leaching when buried in a landfill. Yet, plastic remains an integral part of society with a continued rise in global and North American forecasted production demand. While indispensable, petroleum based plastics have come under scrutiny as consumers seek more sustainable and safe household and recreational products. Hence, the need in recent years for research and development of alternatives to petroleum based plastic. Bioplastics, plastics comprising of renewable biomass sources, are a promising emerging alternative with applications that have just recently become economically competitive to petroleum-based plastics. Nonetheless, many even biologically derived plastics still contain EDCs and materials and there exists a need for plastic products not only derived from biological and renewable materials, but also possessing nontoxic nature. Applying such an alternative plastic in reusable and disposable home and recreational applications provides consumers opportunity to realize these benefits without altering the embedded habits and use applications enjoyed with conventional plastic products.

In one aspect, the present disclosure presents a bioplastic formulation which provides that no endocrine disrupting chemicals (e.g., endocrine disrupting elements) will leach from its contact surface materials. This is achieved by replacing petroleum based polymers, wholly or in part, with biologically derived polymers; and replacing estrogenic and androgenic active chemicals and additives (e.g. fillers, binders, plasticizers) with synthetic or biobased substitutes that are not classified as EDCs or have been verified free from emitting endocrine disrupting activity through appropriate (e.g., in-vitro/vivo testing) lab assays. The bioplastic formulation may be impregnated with biomass fibers and materials, as a composite; to harness the plant's naturally occurring antimicrobial properties, reduce the use of petrochemical feedstock, and for improved mechanical/functional properties in the finished product. Incorporating biological materials into the bioplastic resin creates several advantages including the reduced dependence on fossil fuel feedstock and the beneficial environmental impact resulting from such production. In addition to environmental friendliness, the low density and cost, availability, and recyclability are also notable benefits. Because part of the composition is comprised of biobased and biologically derived materials and/or polymers, the detrimental environmental contamination at the end of the product's useful life is also mitigated, when such materials break down into benign organic matter, without the emission of toxic compounds, upon disposal and degradation. When the nontoxic EDC-free bioplastic is applied to reusable commodity embodiments, further environmental benefit is realized through the resulting reduction in disposable waste. In various implementations, the bioplastic can be made to have equivalent properties and characteristics of other common plastics such as polypropylene, polyethylene, and the like, and yet contain antibacterial substances without using endocrine-disrupting chemicals and materials.

The application also presents the endocrine-disruptor free antimicrobial bioplastic, a method of making the same, and a detailed example of a design embodiment with functional features. Various flexible and/or rigid and/or woven, reusable and/or disposable plastic compositions and applications can be produced from one or more of the biomass plant sources, a carrier resin, and other, preferably biobased additive ingredients. In a composite application; the bioplastic is produced from a base resin, comprised of either fully biobased polymers or in combination with EDC-free petroleum polymers, and naturally antimicrobial plant fibers and materials as the reinforcing agent to the biopolymer. The composite plastic is biobased when feasible, but can also include endocrine disruptor-free and food-safe synthetic materials to achieve desired properties and compositions. The biological matter can be dried or otherwise processed, and can be made into smaller finer particles, even nano-particles; through milling, grinding, or other methods, in order to achieve enhanced dispersion and integration of the biological material into the polymer through extrusion and other appropriate methods of composite manufacture. The composite bioplastic is then shaped to the article of manufacture through a plastic molding method, as determined by the article being produced, such as extrusion molding, injection molding, blow molding, thermoforming, compression molding and the like.

Particularly, an antimicrobial biomass-derived plastic composition for use in the production of an article of manufacture is provided. The compositions of the disclosure can be utilized in many commercial applications that may especially prove beneficial for products that come in contact with food, beverages, and the body because of the nontoxic nature. More specifically, one such application is a reusable food storage container. Such container may be made to include a lid that fits onto the bottom base for space-saving and stacking functionality. Many other desirable features can be added to multiple product embodiments, beyond the food storage container, to encourage adoption of the sustainable nontoxic bioplastic in applications used throughout the home and active lifestyles of modern consumers.

The production process may involve milling the renewable biomass materials, for example plant fibers, through a grinding process into powder form, or start with already pre-ground fibers, both of which are used as a filling agent, reinforcing the bioplastic resin.

Specifically, the compositions described herein and the methods of making rely on bioplastic pellets and mixing the fibers into the plastic. Additional description regarding the method of making may be found in US 2009/0110654, which is incorporated by reference in its entirety for all purposes. Additional information may also be found in Valdés, Arantzazu et al.” Frontiers in Chemistry 2 (2014): 6. PMC, 2017. US20170183469 A1, WO2017087895 A1, US20070189932 A1, CN101955640 B, U.S. Pat. No. 6,083,621 Å, EP0319589 A1, U.S. Pat. No. 6,184,272 B1, or U.S. Pat. No. 8,835,537 B2, which are incorporated by reference in their entirety for all purposes.

It should be understood that the following descriptions are not intended to limit the embodiments or methods of production nor use one preferred embodiment or method. Rather, it is intended to provide examples and to cover alternatives, modifications, and equivalents as can be included within the spirit and scope of the described materials, compositions, embodiments, methods of producing and using the same.

Disclosed herein is the endocrine-disruptor free antimicrobial biopolymer plastic. The bioplastic composition comprises a thermoplastic and/or thermoset, biobased or synthetic, resin and may include multiple ranges, from 0-90% by weight of the finished product, of reinforcing plant fibers and other biological materials. These naturally nontoxic and preferably antimicrobial biological materials are incorporated into the composition as a reinforcing agent to the bioplastic resin. The biomatter particulates not only lessen the environmental impact and health risks associated with conventional fossil fuel-based plastic products, but also add new functionalities such as increased strength, elasticity, and biodegradation rates.

More specifically, the present disclosure presents a bioplastic formulation that shall not contain or leach published endocrine disrupting chemicals (EDCs) nor the associated detectable levels of estrogenic or androgenic activity (EA/AA) in its resins and additives. The manufactured articles derived from the bioplastic composition shall be produced from polymers and additives such as antioxidants, colorants and dyes, preservatives, processing stabilizers, and the like; that have been tested (e.g., lab assayed) and published to not emit detectable levels of EA/AA, and are thus not classified as EDCs, see for example Bittner et al Environ Health. 2014; 13: 41. Through careful sourcing of materials, substances, and manufacturing processes that have been evaluated and reported to not release EA/AA active compounds, the bioplastic formulation and manufacturing process shall intentionally not contain endocrine disrupting chemicals of concern nor carcinogenic substances, differentiating the composition and manufacture from conventional EDC-containing plastics. While there are many benefits, a principle value derived from the disclosed bioplastic is that no detectable levels of estrogenic/androgenic active endocrine disrupting chemicals and substances shall be emitted from the molded product when used by the consumer. The bioplastic refrains from containing toxic chemicals of concern (for example BPA, BPS, or phthalates) that have been identified to potentially leach into the foods and beverages they contact. Mitigating the exposure to plastic environmental toxins and consequential hormone mimicking, blockage, and disruption that has been published and verified in numerous medical journals to occur from such chemicals of concern that are used by conventional plastics, proves especially beneficial for those exposed during early stages of development, like in fetal and adolescent stages of life. Utilizing materials tested to be nontoxic, benefits all stakeholders, whether human or animal; who produce, use, and are otherwise exposed to the raw materials used in the manufacturing process and the ultimate finished product. Not only does the end consumer benefit, but the material handlers as well who are otherwise exposed to chemicals of concern in the manufacture of conventional fossil fuel plastics and their EDC components, i.e. additives and plasticizers.

The polymer resin is preferably sourced from non-fossil fuel, biobased polymer sources, but may also be derived from synthetic EDC-free fossil fuel polymer sources. Examples of the non-fossil fuel bioplastic sources, include but are not limited to one or more of the following thermoplastic and/or thermoset embodiments of: starch and starch derivatives (PVA, PBS); polylactic acid (PLA) and its derivatives; protein derived thermoplastics (from sources like wheat, rice, corn, soy, and casein); chitin and chitosan derivatives; bio-based polyethylene (PE, PET, PA); polyhydroxyalkanoate (PHA) and its derivatives (i.e. polyhydroxybutyrate PHB, polyhydroxyvalerate PHBV, polyhydroxyhexanoate PHH, PLLA, etc.); polybutylene succinate (PBS) poly(butylene adipate-co-terephthalate) (PBAT); polycaprolactone (PCL); polyhydroxyurethanes (PHU); polyhydroxyurethanes (PHU), lipid derived polymers such as those coming from plant and animal fats and oils (such as zein, soya, and gluten); sugars and sugar derivatives; cellulose (cellulose acetate, nitrocellulose, and celluloid) and other cellulose derivatives; lignin and lignin derivatives; yeast and bacteria derivatives; copolymers and blends of biobased resins; and the like. Examples of fossil fuel-derived polymers that may be employed include but are not limited to: polypropylene (PP); polyurethane (PU); polyethylene and its derivatives such as high-density polyethylene (HDPE), low-density polyethylene (LDPE), polyethylene terephthalate (PET) and glycol-modified polyethylene terephthalate (PETG); polyvinylidene chloride (PVDC); polyamide (such as PA, Nylon, etc.); polystyrene (PS) and high impact polystyrene (HIPS); polyester and polyether sulfone (PES); cyclic olefin polymer and cyclic olefin copolymer (COP, COC); silicone; polyoxymethylene; polycarbonate (PC); acrylic (PMMA); acrylonitrile styrene acrylate polybutylene terephthalate; and the like. Furthermore, the disclosure entails any combination thereof and containing copolymer resins.

In the composite embodiment (e.g., the plastic composition), the EDC-free bioplastic formulation contains biological materials integrated within the nontoxic resin. The biological material used is nontoxic; and preferably has naturally antimicrobial properties, nonucleating genetic modification, and is derived from agricultural waste products (e.g., cereal straw, sawdust, woodchips, waste wood particulates, bark, newsprint, paper, or cardboard). The natural feedstock can be sourced from biological varietals including but not limited to one or more of jute, hemp, flax, kenaf, ramie, roselle, mesta, palm, sisal, banana, abaca, palf, henequen, agave, raphia, rice straw, kapok, loofah, cotton, wheat, rice, barley, oat, rye, bamboo, bagasse, corn, sabai, rape, esparto, canary, African kino, sugarcane, pine, cacao, coffee, nuts, olive, coconut, pineapple, mango, pomegranate, blueberry, apple, orange, lemon, lime, grapefruit, grape, watermelon, tomato, potato, avocado, seaweed and algal derivatives, other reeds/grasses, tree varietals, and the like. Of those referenced and like vegetable and plant species, any and all parts of such plant materials can be used as a source for the biological material. For example, this includes the fibers, stalk, cob, skin, peel, coir, husk, hull, pulp, shell, leaf, baste/stem, straw, root, seed, pod, bean, oil and the like; allowing for use of the plant in its totality. Using agricultural waste materials allows for the effective repurposing of the otherwise discarded biological waste matter into value-added applications.

The biomass material feedstock used may be dried and further processed, usually ground into smaller finer particles, for example in microsized or even nanosized particle form, for enhanced dispersion and integration into the polymer, for example through extrusion compounding. The fiber/particle length of the biological materials used can be from any length and aspect ratio without limitation according to what is determined most suitable per application. The percentage by weight of plant materials that can be included in the bioplastic product can be in any of the ranges of 0-10, 10-20, 20-30, 30-40, 40-50, 50-60, 60-70, 70-80, 80-90, and 90-100 wt %. These plant particles are incorporated within the biopolymer plastic base resin.

In another aspect, the bioplastic composition and the ultimate finished-product shall also retain antimicrobial/antibacterial and/or antioxidant properties. Antimicrobial properties can be imparted through, preferably but not limited to, the inherent chemical properties of the one or more plant fibers and materials that are incorporated throughout the bioplastic composition, whether in powder or some other particle form. Many of the aforementioned biological materials listed for potential use in the composition may possess biologically inherent antimicrobial chemistry properties, which are retained when integrated into the bioplastic composition, and ultimately possessed by the finished product. In addition to plant materials as a source of the bacterial inhibiting properties, other ingredients may be added to provide for and/or supplement the antimicrobial nature of the manufactured bioplastic article. These include in potential combination and without limitation; plant extracts like blueberry, grape seed, green tea; essential oils; silver particles and derivatives; chitosan; algae and algae derivatives; agricultural waste products; and/or any other natural extract that contains antimicrobial active properties. These substances, whether plant materials or other additives are mixed into the plastic resin, in our example just before the extrusion process in phase of FIGS. 1A-1B, to form a homogeneous mixture allowing for the end bioplastic product to contain similar antimicrobial properties because of their incorporation. The addition of such materials, extracts and additives that possess an antimicrobial and/or antioxidant nature prove especially useful to control bacterial growth on food and beverages stored in the manufactured articles. Such feature can aid in preventing or reducing food, beverage, and surface borne microbial spoilage and growth, adding value to the end-product.

The compositions of the disclosure may be employed in many uses having a wide variety of applications and is in no way limited in the scope of potential uses, especially in applications common to conventional fossil-fuel derived plastics. In some embodiments, the molded products may be food storage containers, storage and freezer bags, dining ware, serve ware, cutlery, cooking utensils, kitchen gadgets, cups, caps and lids, snack and freezer storage bags, beverage and baby bottles, spray bottles, pitchers, liquid pourers and dispensers, ice-trays, spice holders, condiment dispensers, baking ware, baking accessories, toothbrushes, blenders, baby products and toys, cosmetic containers, soap and body care dispensers and holders, deodorant containers, pens and pencils, phone cases, wrist bands, watchbands, pet feeders and bowls, headphones, cables and housing, bins and baskets, grocery and shopping bags, waste baskets, toys, textiles, furniture and the like. While many of the above embodiments can be categorized as reusable applications, the bioplastic and its variations can also be employed in disposable applications, such as snack and trash bags; single-use cups, plates, cutlery; packaging and the like. Recreational applications also present promising potential for uses outside the home in active lifestyles, whether sports, camping, exercising, hiking, or simply on-the-go portable applications. The bioplastic can also be integrated into other products; for example, integrated within appliances, furniture, and vehicles, as component parts used in a variety of simple and integrated articles of manufacture. One such embodiment is a plastic food storage container designed in order that the lid not only fastens onto the top parameter of the container, but also fastens or rests onto the bottom of the container base for storage and stacking functionality. A rim exists on both the top and bottom of the midsection to hold the lid on top and when resting on bottom, respectively. This is just one example of an embodiment of the biopolymer plastic and is not limiting in shape, size, color, dimension, or other characteristics.

In accordance with some aspects, an endocrine-disruptor free bioplastic composite may comprise: a plastic material (preferably bioplastic in nature); a processed biological material integrated with the plastic material, the natural antimicrobial components of related materials; and may include further nontoxic stabilizing agents, bonding agents, coloring agents, impact modifiers and other appropriate agents (preferably naturally derived).

In accordance with certain embodiments, a method of integrating the ground biomaterial into the EDC-free plastic material is provided, where processed ground materials is incorporated into composite forms for molding into the desired application.

In certain embodiments, the bioplastic composition is configured for use in the manufacture of a food storage container. In particular, a molded endocrine-disruptor free bioplastic food container is provided, wherein the container lid fastens onto the top parameter of the container. The lid may also fasten or rest onto the bottom of the container base for storage and stacking functionality. A rim exists on both the top and bottom of the midsection to hold the lid on top and when resting on bottom, respectively. This is just one example of an embodiment of the biopolymer plastic and is not limiting in shape, size, color, dimension, or other characteristics.

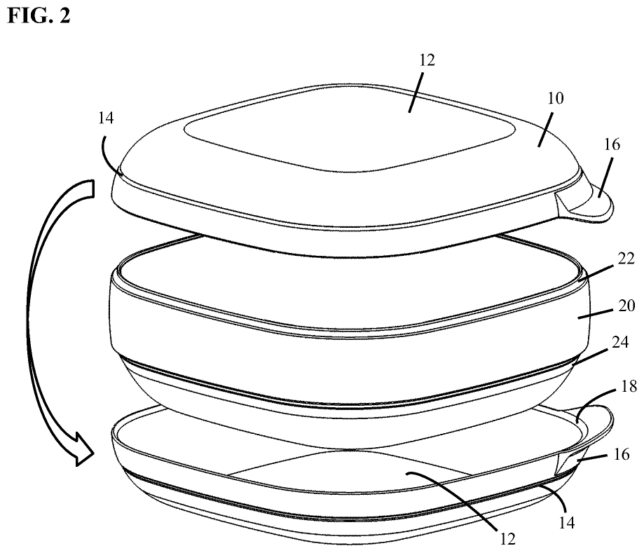

FIGS. 2 through 6B illustrate a rendering of the bioplastic's application in a plastic food storage container: schematic, diagram, and elements of the working example. In this application, the container is designed in order that the lid (10) not only fastens onto the top of the container, but also fastens or rests onto the bottom of the container base (20) for storage and stacking functionality. This functionality serves to mitigate the problem of having to store lids separate from their container bases, which creates clutter during storage and can cause difficulty when trying to match the correct lid with the correct base. This problem is solved by utilizing a nesting design that allows for a single unit, connected based and lid, during storage. An interlocking feature, a rim (18) in this embodiment, exists on both the top (22) and bottom (24) of the midsection of the base (20) and inner perimeter of the lid (18) in order to hold the lid on top and when resting on bottom, respectively. This is just one example of an embodiment of the EDC-free biopolymer plastic application and is not limiting in shape, size, color, dimension, or other characteristics.

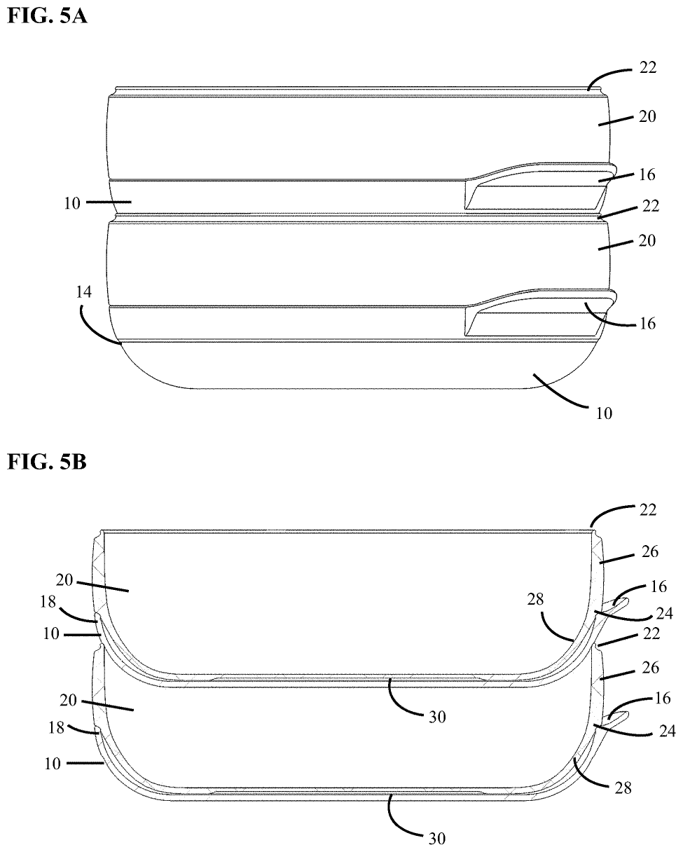

FIG. 2 depicts one lid (10) and a container base (20), wherein the lid (10) fastens onto both the top rim (22) and base of the container. There are not two lids, but rather the arrow serves to illustrate the flipped nesting position and functionality of securing a single lid onto both the top and bottom of the container. The lid (10) features a transparent viewing surface (12), in this embodiment the transparent viewing surface (12) is located on the top of the lid (10), but alternatively the entire lid itself can be made from a transparent or semi-transparent plastic, as disclosed herein, to allow for a greater viewing surface. By transparent, it should be noted to include both semi-transparent or milky viewability as well as clear and fully transparent surface finishes. Surrounding the outer surface of the lid is a slight indentation (14), which functions to provide a resting point when in the upside-down nesting position, as further depicted in FIGS. 5A-5B. The lid also features a protruding lip (16), which allows for the lid (10) to be easily removed on or off, functioning as a surface for fingers to grip. An interlocking rim (22) is featured around the top perimeter of the container base and bottom of the midsection (24) to fasten the lid on the top of the container when storing contents and to fasten the lid on bottom when nesting in the upside-down position, respectively. A rim feature (18) that follows the inner perimeter of the lid is the counter piece to the interlocking mechanism that holds the lid onto the base and bottom of the container per its respective uses. This is just one example of an embodiment of the biopolymer plastic application and is not limiting in shape, size, color, dimension, or other characteristics.

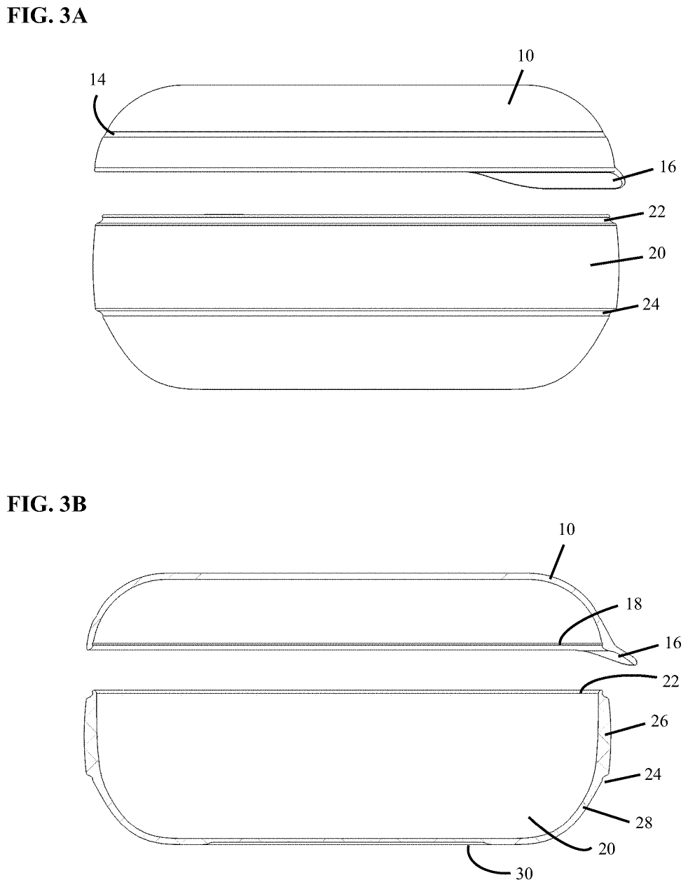

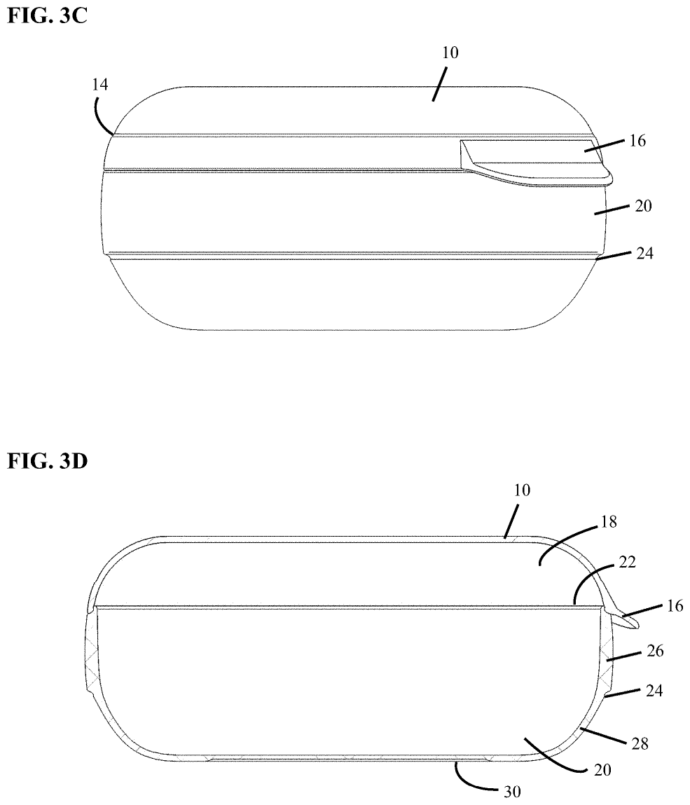

FIGS. 3A through 3D illustrate how the lid (10) fastens onto the top rim (22) of the container (20), including sectional views to depict the interlocking rim features around the container's top and lower midsection as well as lid perimeter (18), that serves to fasten the lid (10) onto the top when covering the container contents. The sectional view in FIGS. 3B, 3D shows how the container base (20) features a thicker wall of material (26) in the midsection and thinner wall of material (28) in the lower curved portion of the base, which allows for the lid (10) to become flush with the thicker wall of the midsection when nesting upside down on the bottom of the container as further depicted in proceeding figures. The sectional view further depicts the concave indentation (30) on the bottom surface of the container base, which serves to enhance stability when stationary on surfaces and mitigate sliding or floating movement when placed on wet flat surfaces, for example a counter or table top.

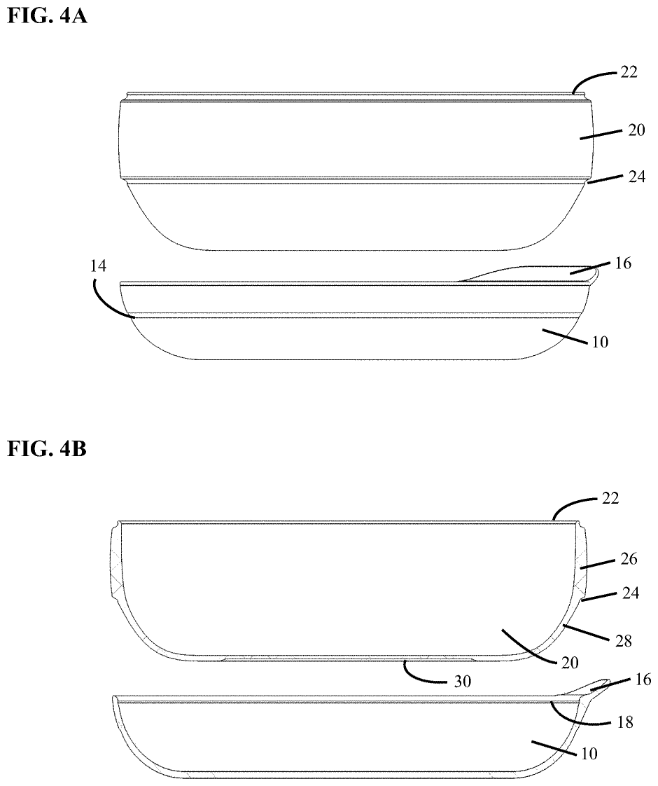

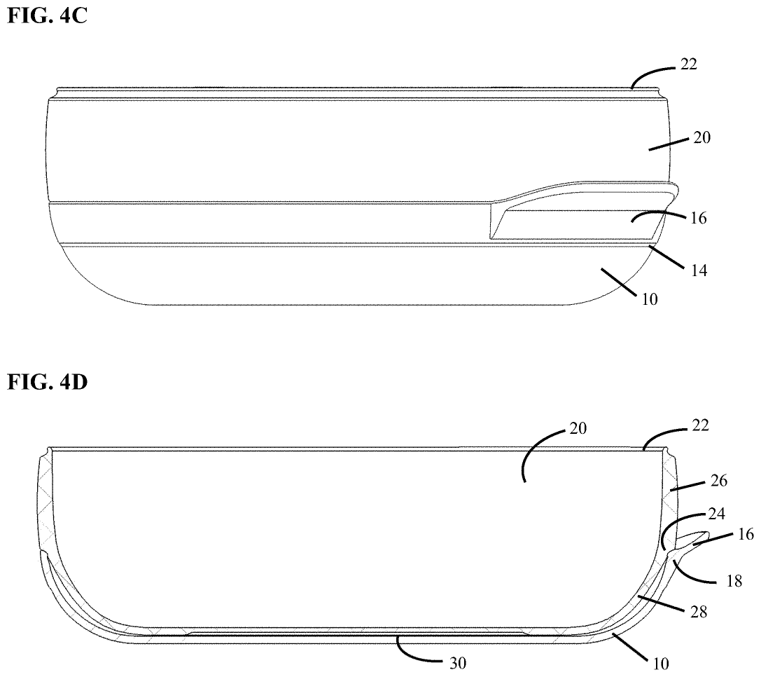

FIGS. 4A through 4D illustrate how the lid (10) fastens onto the bottom of the container base (20), with sectional views to convey the interlocking lid (18) and base feature (24) that fastens the lid onto the bottom when accessing contents in the container or storing when not in use. The inner rim around the parameter of the lid (18) fastens onto the indentation (24) that wraps around the lower portion of the container's midsection. The sectional view in FIG. 4D shows how the container base (20) features a thicker wall (26) of material in the midsection and thinner wall (28) of material in the lower curved portion of the base, which allows for the lid (10) to become flush with the thicker wall of the midsection when nesting upside down on the bottom of the container as depicted. The flush surface not only offers aesthetic appeal, but also a smooth surface when porting or storing the container without unnecessary material protrusions.

FIGS. 5A through 5B depict the stacking functionality when storing two containers on top of each other. As seen in the sectional view in FIG. 5B, a portion of the container rests within the underlying container to save space during storage. The subtle indentation (14) that follows around the surface of the lid (10) serves as the resting point where the upper container rests to such depth within the underling container. This indentation point (14) further allows for a ridge of stability when stacking to minimize movement between the upper and lower containers. Further, because the wall (28) of the lower portion of the base is thinner than the upper (26), which allows for a flush surface along the container sides when in the nested position, the two containers stacked vertically remain parallel and minimize space taken up when stored in this upright position. FIGS. 5A-5B emphasize how the lid (10) and base (20) fasten to form a connected unit for each container, which allows for ease of storage and use, as well as mitigates the need to separately store or find the matching top and bottom pieces.

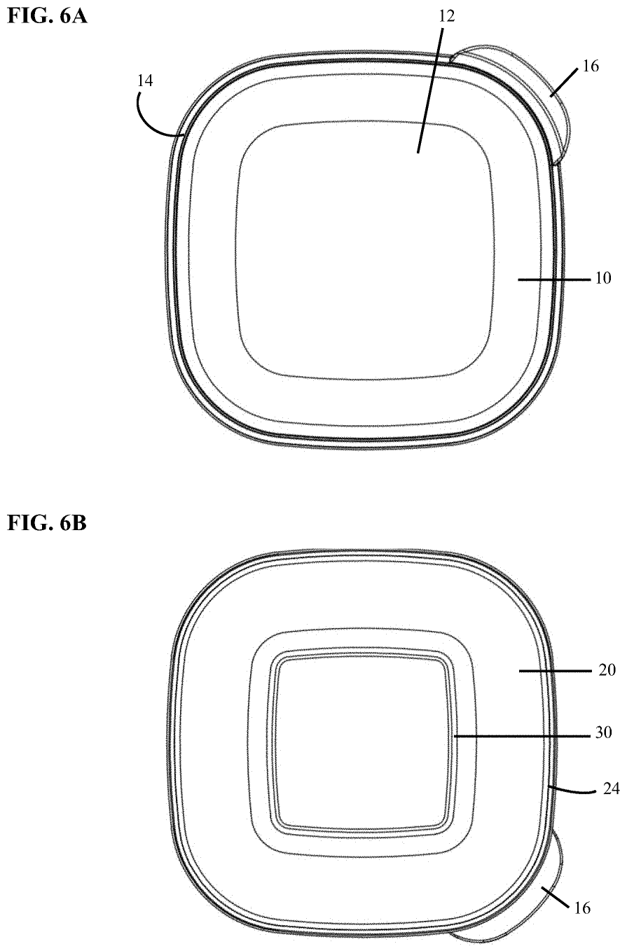

FIGS. 6A through 6B depict an aerial view of the container when closed with the lid on top. and bottom FIG. 6B shows the top view of the lid (10), which emphasizes the (semi)transparent viewing surface (12), which allows for viewing of the container's contents without taking the lid off. FIG. 6A also depicts the rim (14) and lip (16) features placed on the lid. In FIG. 6B, the bottom view of the container base (20) if viewing upwards in perspective from the bottom base with the lid attached on top. FIG. 6AB depicts a potential concaved indentation (30) in the bottom for increased stability when resting stationary rather than if the container bottom was a completely flat surface.

What is claimed is:

1. A composition comprising:
one or more polymers;
one or more additives or fillers; and
one or more biologically derived components including at least one of the one or more polymers or one or more additives or fillers,
at least one of the one or more polymers or the one or more additives or fillers being substantially free of endocrine-disrupting compounds.

2. The composition of claim 1, wherein the one or more polymers include a nontoxic polymer that comprises at least one of a thermoplastic polymer, a thermoset polymer, an elastomeric polymer, or copolymer blend thereof.

3. The composition of claim 1, wherein at least one of the one or more polymers is derived from at least one of a living organism or synthesized chemical reactions, the synthesized chemical reactions including a polymerization process.

4. The composition of claim 1, wherein the one or more biologically derived components include at least one of a biopolymer, a biobased additive, or a filler component derived from a living organism.

5. The composition of claim 4, wherein the living organism is at least one of a plant, fungus, animal, protist or bacteria.

6. The composition of claim 1, wherein the one or more polymers comprise at least one of a natural polymer, a biopolymer, or a bioderived copolymer blend.

7. The composition of claim 6, wherein the natural biopolymer comprises at least one of: polylactic acid (PLA), polyhydroxybutyrate (PHB), polyhydroxyalkanoate (PHA), biobased polypropylene (bio-PP), biobased polyethylene (bio-PE), biobased polybutylene succinate (bio-PBS), polysaccharides, thermoplastic starch (TPS), or a copolymer blend.

8. The composition of claim 1, wherein the one or more polymers include a synthetic polymer.

9. The composition of claim 1, wherein the one or more additives comprise at least one of: a nucleating agent, an antimicrobial agent, a colorant, a coupling agent, a binding agent, a degradant, a stabilizer, a modifier, a softener, a clarifier, a plasticizer, an antioxidant, a lubricant, or a processing aid.

10. The composition of claim 4, wherein the filler component is a processed biological material.

11. The composition of claim 9, wherein the processed biological material is derived from at least one of: jute, hemp, flax, kenaf, bamboo, coir, sisal, banana, abaca, wool, starch, or chitin, or a combination of biologically derived sources.

12. The composition of claim 1 comprising a plastic material safe for food contact and suitable for use in at least one of a microwave or dishwasher.

13. The composition of claim 1, wherein the endocrine-disrupting compounds comprise chemicals that disrupt endocrine system pathways, including at least one of: bisphenol A (BPA), bisphenol S (BPS), bisphenols, phthalates, or dioxin.

14. A method of making a plastic composition comprising at least one of: one or more nontoxic polymers, one or more nontoxic additives, or nontoxic fillers, the plastic composition being nontoxic, substantially free of endocrine-disrupting compounds and derived in-part from biological origins, the method comprising compounding a nontoxic polymer to form a nontoxic plastic composition substantially free of releasing detectable endocrine-disrupting compounds and derived in-part from biological origins.

15. A molded plastic comprising the plastic composition of claim 1, wherein the molded plastic is a consumer or industrial product comprising at least one of: a container, a covering, a food storage container, a tableware article, a flatware article, a cookware article, a baking-ware article, a serve-ware article, a dining-ware article, a holder, a dispenser, a tray, an electronic component housing, a toy, a teether, a wearable, an oral appliance or instrument, an animal feeder, a writing device, an article of decoration, a textile, an automobile component, a piping, or a furniture article.

16. The molded plastic of claim 14, wherein the molded plastic is a storage container comprising: a body, a top covering that fits onto an opening of the body.

17. The molded plastic of claim 15, wherein the top covering features a connecting member that joins the top covering and body together.

18. The molded plastic of claim 15, wherein at least one of the top covering or the body features a viewing surface that is transparent or translucent.

19. The molded plastic of claim 15, wherein the top covering, positioned in a first direction, fits onto the body when laid against a first surface of the body.

20. The molded plastic of claim 15, wherein the molded plastic comprises a first container and the top covering lies at a depth within an underlying second container, when the first container is stacked against the second container.
